(19) United States
(12) Patent Application Publication
(10) Pub. No.: US 2014/0076967 A1
(43) Pub. Date: Mar. 20, 2014

(54) MOBILE DIGITAL SIGNATURE READER

(71) Applicants: Nicholas Pushkin, Sankt-Petersburg (RU); Vladimir V. Kitlyar, Sankt-Petersburg (RU); Sergey Lebedev, Bryansk (RU)

(72) Inventors: Nicholas Pushkin, Sankt-Petersburg (RU); Vladimir V. Kitlyar, Sankt-Petersburg (RU); Sergey Lebedev, Bryansk (RU)

(73) Assignee: RAWLLIN INTERNATIONAL INC.

(21) Appl. No.: 13/622,226

(22) Filed: Sep. 18, 2012

(51) Int. Cl. G06K 5/00

(52) U.S. Cl. 235/380

(57) ABSTRACT

Disclosed are systems and techniques that communicate data from a smart card to a smart card reader component and a computer device for an online application, transaction, or service. A smart card reader component converts data from the smart card to audio data and communicates the audio data to the computer. The smart card reader component is a portable component that communicates account data, personal identification data, digital signature data and authentication data to an online application via a network.

### TECHNICAL FIELD

The subject application relates to reading digital content and operations related to reading digital content.

### BACKGROUND

A smart card (SC), chip card, or integrated circuit card (ICC), is a pocket-sized card with embedded integrated circuits. A smart card or microprocessor card contains volatile memory and microprocessor components. The card can be made of plastic, generally polyvinyl chloride, but sometimes acrylonitrile butadiene styrene or polycarbonate. Smart cards may also provide strong security authentication for sign-on within organizations.

There are many benefits to a smart card. For example, a smart card can be programmed to allow a contactless transaction if it is also within range of another device like a uniquely paired mobile phone. This can significantly increase the security of the smart card.

Contact smart card readers are used as a communications medium between the smart card and a host (e.g., a computer, a point of sale terminal) or a mobile telephone. A smart card reader, for example, is an electronic device that reads smart cards. Some keyboards have a built-in card reader. There are external devices and internal drive bay card reader devices for computer devices. For example, some laptops have a built-in smart card reader. External devices may have a keyboard to enter personal identification number (PIN) or other information. Those devices usually are called “card readers with PIN pad”. Some laptops have a flash upgradeable firmware. The card reader supplies the integrated circuit on the smart card with electricity. Communication is done via protocols and you can read and write to a fixed address on the card.

Some smart card reader devices work with USB devices and do not need device drivers when used with Personal Computer (PC)/SC-compliant operating systems, because the operating system (OS) supplies the drivers by default. Today, smart card reader devices are not in broad usage and tend to be device-specific.

The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for a system to execute an online application and/or transaction are contained herein. An exemplary system comprises a memory that stores computer-executable components, and a processor, communicatively coupled to the memory, that facilitates execution of the computer-executable components. The computer-executable components can include a smart card reader component configured to convert data read from a smart card to audio data in connection with a transaction for a product or a service, and a digital signature component configured to, in response to reception of the audio data, determine digital signature data including personal identification data from the audio data. The system further includes a transaction component configured to process at least a portion of the transaction based at least in part on the digital signature data.

In another non-limiting embodiment, an exemplary apparatus comprises a memory storing computer-executable instructions, and a processor, communicatively coupled to the memory. The processor facilitates execution of the computer-executable instructions to at least: convert data read from a smart card to audio data in connection with a transaction for a product or service of a networked application, determine, from the audio data, digital signature data including an identity, authenticate the identity associated with the digital signature data, initiate performance, in response to authentication of the identity of at least a portion of the transaction, and communicate at least part of the audio data to the networked application.

In yet another non-limiting embodiment, an exemplary method includes receiving, by a smart card reader component including at least one processor, data from a smart card in connection with a transaction or online application for a product or a service. The method includes converting the data to audio data, communicating, in response to reception of the audio data, the audio data that includes in part identity data and a digital signature to be used in connection with processing the transaction or online application, and processing at least part of the transaction or online application based on the identity data and the digital signature.

In still another non-limiting embodiment, an exemplary computer readable storage medium comprising computer executable instructions that, in response to execution, cause a computing system including at least one processor to perform operations. The operations comprise receiving, by a smart card reader component, a data from a smart card, converting the data to audio data, communicating the audio data via an audio jack to a computer device that is communicatively coupled to a first network, and in response to a request from the first network including account data, communicating at least a part of the audio data that corresponds to the request and at least one of digital signature data, personal identification data, or authentication data.

In another non-limiting embodiment, a system is disclosed having means for reading and generating audio data from data stored on a smart card, means for providing at least part of the audio data to an online application for a transaction in response to determining at least personal identification data from the audio data, and means for communicating at least part of the audio data based on a request from the online application via the network, wherein the audio data includes transaction data, digital signature data or authentication data.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates an example system in accordance with various aspects described herein;

FIG. 6 illustrates an example process flow in accordance with various aspects described herein;

FIG. 7 illustrates an example of flow diagram in accordance with various aspects described herein;

FIG. 8 illustrates another example of a flow diagram in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In consideration of the above-described deficiencies among other things, various embodiments are provided for a smart card reader component, which may be used on any computer device and/or mobile device with a network connection. The smart card reader is configured to communicate to a second device (e.g., laptop, personal computer, mobile device, or other computer device) in various protocols, such as with an audio communication protocol via an audio jack and/or via other access components or connectors. The smart card reader can be carried separately as a single, portable device by an end-user and plugged into any handheld, mobile or desktop computer device to read information from a card, such as a credit card, a smart card, and/or any identification card. The smart card reader can include a conversion component to convert image or digital information into audio information and output the audio data in an audio format and other formats (Near field communication, Bluetooth, Wi-Fi, ZigBee, etc.).

In one example, a user has a small device or apparatus (e.g., smart card reader component) equipped with an audio jack and a card reader, an integrated circuit (IC) card holder, a subscriber identification module (SIM) card holder, and/or a computer device communicatively coupled to the apparatus with a network connection to a document management server, a financial institution or other remote host, for example. One advantage of the apparatus is that a user can carry it separately and use it as desired on any mobile, handheld, notebook, desktop or any other computer device with a preinstalled application, such as dedicated semantic web (SW) application. The device can also communicate in additional ways other than via audio data through an audio jack, such as by Near Field Communication (NFC), Bluetooth, Wi-Fi, a magnetic stripe and/or other communication protocols with a smart card and with the computer device (e.g., a mobile device) having a network connection (e.g., a wide area network, local area network, and the like).

In the case of a financial transaction, a user can connect the small device equipped with the audio jack into an audio jack of a computer device. Data is read from an IC card or any other device containing user digital identity (e.g., personal identification data, transactional data, digital signature and/or authentication data) into the computer device, and the computer device executes the financial transaction with the remote host. The computer device can enter the data into appropriate fields of an online application (e.g., a bank portal, shopping portal, etc.) and enter the information for the remote host to further process a payment for a product or service. The authentication and authorization data is provided by the IC card or similar memory chip with the computer device. As an additional benefit, a user is not required to enter a personal identification number (PIN), login information, password data, license verification, age confirmation, signature data, payment data, authentication data, and the like to transact with various online or local services or other data that are hosted by a remote host, such as a document management server, a financial institution, or the like.

In addition, the small device or apparatus can also be used for digital document management. A user, for example, may be required on her computer device to digitally sign a given document. The user attaches the small device that is equipped with the audio jack into an audio jack port of the computer device to sign and send the document. Signing, for example, can be performed by generating a hash of the document on the computer device, sending it via the small device equipped with the audio jack to the IC card or similar card, signing it and returning it to the computer device. In turn, a dedicated application can attach it to the document and send to the designated destination.

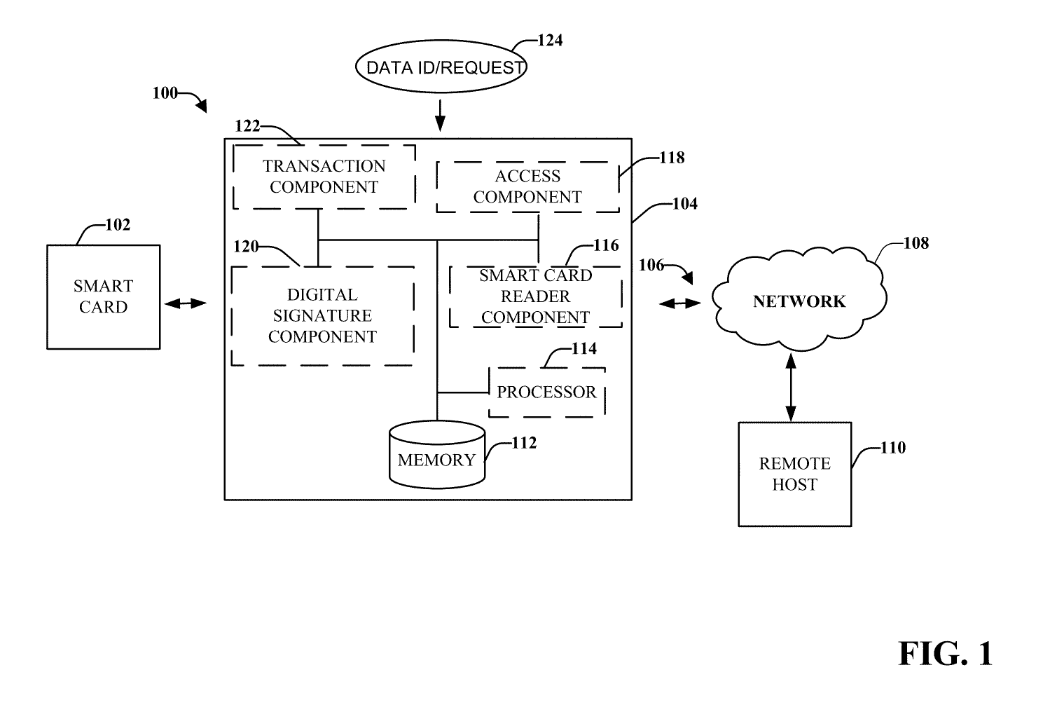

Referring initially to FIG. 1, illustrated is an example system 100 that operates to read digital data (e.g., from a smart card, an IC card, SIM card and other similar identification or key device) and to further output information obtained to an online application. The system 100 comprises a smart card 102, a networked device such as a computer device 104 with a connection 106 to a network 108 (e.g., WAN, LAN, or the like) and a smart card reader component 116 that can be integrated with the computer device 104 and/or separable from the computer device 104.

The computer device 104 comprises a memory 112 that stores computer executable instructions and data obtained from the smart card 102. The computer device 104 further includes, for example, a processor 114, the smart card reader component 116, an access component 118, and a digital signature component 120, and a transaction component 120. Data from the smart card 102 is read by the computer device 104 and provided to the network 108 in response to a data request 124 to be applied to an online application of a remote host 110.

The smart card reader component 116 is configured to interface with the smart card 102 with various communication formats/protocols. The smart card reader component 116, for example, can communicate with an NFC protocol, a magnetic communication, a Bluetooth communication protocol, a Wi-Fi and/or wireless communication protocol and the like with the smart card 102, and/or with the computer device processor 114. In one embodiment, the smart card reader component 116 is operable to establish a communication (e.g., a radio communication) that is contactless. For example, the smart card reader component 116 can establish communication with the smart card 102 via a contactless communication when the smart card 102 is proximately located (within a predetermined close range) to the smart card reader component 116.

The smart card reader component 116 is configured to convert digital data received from the smart card 102 into another format, such as audio data. For example, the smart card 102 can be configured with an NFC tag or chip that allows a two way communication with the smart card reader component 116 when in close proximity or farther away with wireless and/or wired communications. The smart card reader component 116 can include a reader head (not shown) that reads information embedded in a magnetic stripe on the smart card 102. For example, a magnetic reading component or other signal receiving component of the smart card reader component 104 can obtain data when in contact with the smart card 102. Therefore, various communication protocols can be used simultaneously by the smart card reader component 104 to obtain, or receive data from a smart card.

The smart card reader component 116 is operable to convert data obtained from the smart card 102 into an audio formatted protocol, and in turn, communicate the audio information via the access component 118 (e.g., audio jack, USB and the like). For example, the computer device 104 can be a personal computer, a mobile device, a wired or wireless device, such as a mobile phone, a personal digital assistant or other hand-held device. In addition, the smart card reader can also be a mobile, separable device that connects wirelessly and/or with a wired connection to the computer device.

The access component 118 of the computer device 104 is configured to receive and communicate audio data to the computer device memory 112 and/or the processor 114. In one embodiment, the access component 118 is configured to output audio data from the smart card reader component 116 to the memory 112 and/or the processor 114. The access component 118 is communicatively coupled and/or integrated with the smart card reader 116 and can comprise an output device, such as an audio jack or some other output device (e.g., USB and the like) for transferring audio data to the computer device 116 and the network 108.

The access component 118 can enable the smart card reader component 116 to be combined with the computer device 104 to form a single unit and also operate as a separable mobile component that can be removed from the computer device 104. For example, when the computer device 104 is connected to the network 108, the smart card reader component 116 can be combined with the computer device 104 to communicate various types of data in an audio or other format to an online application of the remote host 110, which can comprise a server, a website hosting client or other online remote host.

In one example, the computer device 104 can be a smart phone that is connected to a network (e.g., a WAN) at a web portal that combines a diversity of internet sources (e.g., any combination of a search engine, e-mail, news services, stock information, other information, databases, entertainment, etc.) with access control and procedures for multiple applications and databases, which otherwise could be different entities. Upon receiving or accessing an online application of the portal that request data (e.g., data request 124), the computer device 104 can receive a mobile device, such as the smart card reader component 116 via the access component 118 (e.g., an audio jack, audio port, wireless link, USB, and the like). The smart card reader component 116 and the smart phone then become integrated in order to obtain, store and communicate data from the smart card 102.

The smart card reader component 116 is configured to obtain, store and update data from the smart card 102 and/or to the smart card 102. The payment or the transaction component 122 is configured to communicate account data, such as transactional data for processing or sharing data for a payment requested by the online application and/or online transaction. For example, the transaction component 122 is operable to identify that an online application is requesting a payment, or otherwise has payment options for a user to enter payment information for a service or product. In one embodiment, the computer device 104 can use the transaction component 122 to identify payment data fields at an online application, and in response to the user swiping, proximately locating, and/or wirelessly transmitting information from the smart card 102 or a credit card, the computer device 104 auto-fills the fields for payment for processing, or, otherwise, to process at least a portion of the transaction based at least in part on digital signature data. For example, a transaction can include an exchange for a good and/or service, and/or be for an application for an exchange of a good and/or service.

In addition or alternatively, a data ID/request can be received, and in response to the request (e.g., a communication from an online application of the remote host 110 or identification of payment fields), the payment component 122 communicates the payment data obtained from the smart card 102 via the smart card reader component 116 for processing a transaction related to a good and/or service.

The digital signature component 120 is further configured to, in response to reception of the audio data, determine and communicate a digital signature data, such as a digital handwritten signature, personal identification data and/or an electronic digital signature to the processor 114 and/or the memory 112 of the computer device 104. For example, in response to a portal or other online application requesting a signature, the smart card 102 can be placed in proximity to the smart card reader component 116, swiped for a magnetic stripe data to be read from the card, communicate wirelessly and/or communicate via a wired connection to the smart card reader component 116. The smart card reader component 116 detects data requested by the portal on the smart card 102 and extracts, obtains and/or, otherwise receives the data to populate signature data fields at a data signature field, the network application, website and/or portal with the signature data.

In one embodiment, the computer device 104 receives the signature data (e.g., a electronic signature) from the digital signature component 120 or the transaction component 122 in an audio format via the access component 118, such as an audio jack or other communication connection. The transaction component 122, the digital signature component 120 and/or the computer device 104 is configured to utilize the data obtained from the smart card 102 to populate the network fields or application fields based on the requested information, based on the fields identified (e.g., via a semantic web application), and/or based on the type of request received. For example, the digital signature component 120 can populate digital signature data to satisfy digital signature requests received, and/or fields or documents identified that ask for digital signature data. The transaction component 122 also provides transactional data extracted or received from the smart card 102. Additionally, the computer device 104 can do the same operations with account or payment data (e.g., account numbers, credit card numbers, routing number, billing address, zip code, security keys and the like) transactional data, and/or identity data (e.g., personal identification) received from the transaction component 122 and the digital signature component 120, and the smart card reader component 116 for providing payment information to satisfy payment request or an online data field asking for any particular data in relation to the online transaction and/or application.

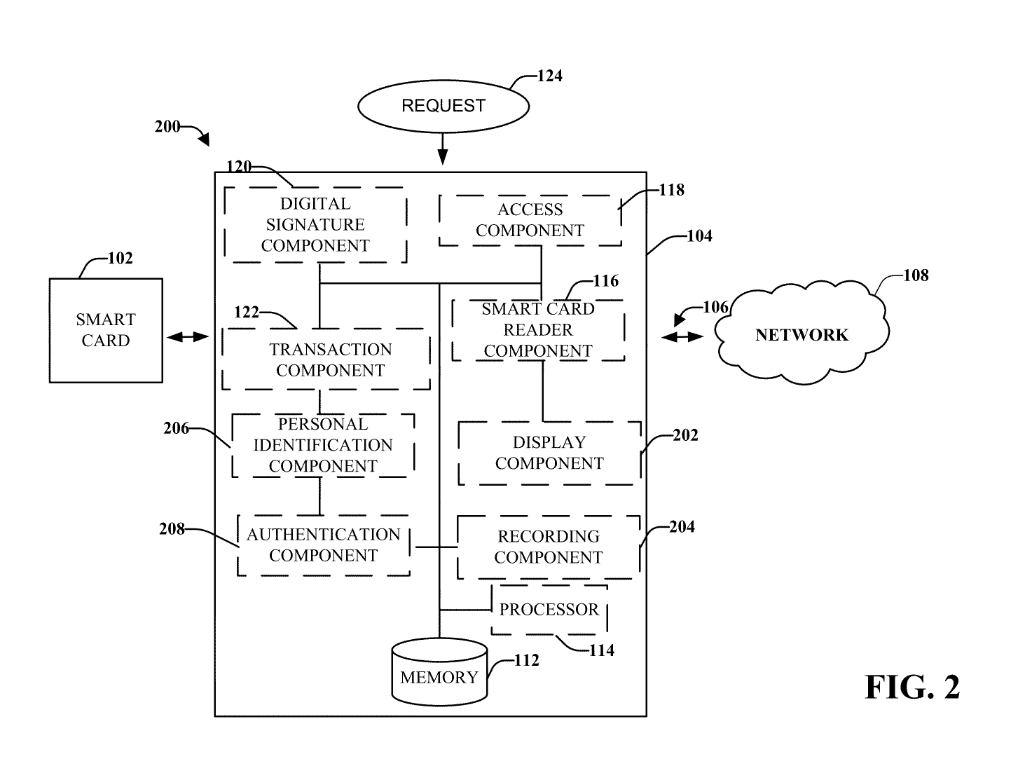

Referring now to FIG. 2, illustrated is an exemplary system 200 for reading a smart card 102 with a smart card reader component 116 and a computer device 104, such as a mobile device, handheld device and the like that communicatively connects with the smart card reader component 116.

While the smart card reader component 116 and the computer device 104 are illustrated as a single integrated unit, the smart card reader component 116 and the computer device 104 can be separate devices, such as separate mobile devices, for example. The computer device 104 also includes a memory or data store 112 and a processor 114. The smart card reader component 204 is communicatively coupled to a display component 202, a recording component 204, and the payment and digital signature component 122. The transaction component 122 and digital signature component 120 is configured to, in response to reception of data from the smart card reader component, process a payment related to the transaction and communicate digital signature data for application to a digital document related to the transaction to electronically sign the digital document. The transaction component 122 and digital signature component 120 are configured to receive the audio data from the smart card reader component 116 and/or receive digital data extracted from the smart card 102 by the smart card reader component 116, and communicate the data received that relates to a transaction for goods and/or services.

The transaction component 122 and digital signature component 120 is communicatively connected to a personal identification component 206 and an authentication component 208. The personal identification component 206 is configured to, in response to reception of the audio data and/or other formatted data extracted from a smart card, communicate personal identification data, such as citizen status, an electronic driver's license, birth certificate, social security data, name, age, birth, residence, address, etc. about an individual cardholder of the smart card 102. The personal identification component 206 can identify, store and update data from the smart card, and communicate back and forth with the smart card reader component 116 data. For example, specific information from the smart card can be identified, such as a name, and communicated from the smart card reader component 116 in the form of audio data and/or another formatted data. The smart card reader component 116 is configured to communicate the personal identification data with the personal identification component 206 to the network 108 in response to a personal identification request or an online application request for personal identification data. Further, the authentication component 208 is configured to identify, store, and update authentication data, such as Personal Identification Number (PIN), password, and/or other key to enable two-factor authentication processes online and/or with a vendor. In cases, for example, where an underage restriction is in place, a digital driver's license or digital citizenship card digitally incorporated in the smart card can also be extracted and communicated by the authentication component 208 coupled to the smart card reader component 116.

For example, a user could swipe, proximately locate, and/or wirelessly communicate data from the smart card 102 to the smart card reader component 116 for a product or service. The computer device 104 is then operable to receive the data (e.g., transactional data, digital signature, personal identification data, and/or authentication data) based on either a request 124 from an application (e.g., a payment application) and/or from fields identified for an electronic form, for example. Therefore, a user is able to have an integrated payment online experience when paying for products/services with their mobile phone and/or the smart card reader component 116.

In another example, a user navigates to a website to pay for a product or a service integrating their mobile device or computer device with the smart card reader, the user can automatically pay for payments based on the smart card chosen from the user's wallet, and process the payment. The user can also enter a store with his or her smart phone, pick up items to purchase and pay for them with their smart card of choice, smart card reader component, and a mobile device. The store can detect that the user has paid for the item through any number of various means, and the user could exit the store with the items without having to stay in a self-check-out line or a cash register line.

In one example, a user can choose a card to use, swipe the card in the smart card reader component 116, and provide the smart card reader component 116 to the store register, where the signature data, the transactional data, and/or personal identification data is provided for based on a request from the store's application. Additionally, authentication data, such as a PIN, login information, and/or other two-factor authentication is also provided via the smart card reader component 116. The payment and digital signature component 112 can be included with the computer device 104 and/or the smart card reader component 116, in order to specifically identify, read, extract, store, and/or update data with the smart card 102 and the smart card reader component 116, in which the data can comprise image and/or object data that is converted from a digital object or image into audio data by the smart card reader component 116. The audio data can them be processed for an integrated online experience that can include access to websites, transactions, authorizations, and authentications, for example.

The smart card reader component 116 is further communicatively coupled to a display component 202 that displays information received from the smart card 102, such as transactional data, personal identification data, a digital signature, and/or authentication data. This enables a user and/or a vendor to view information from the smart card 102 either partially and/or entirely, in which some or all of the data could be blocked or encrypted from viewing also.

The smart card reader component 116 is further communicatively coupled to a recording component 204 that is configured to receive and record at least one receipt of communication between the smart card reader component 116, the computer device 104 and/or to an online application via the first network 108. The recording component 204 can detect transaction or information that sensitive, such as from the smart card 102, and record a ticket or receipt that the data was shared to the network 108, the computer device 104 and/or the smart card reader component from the smart card. The receipt can include a time data, a type of transaction or type of information that was shared (e.g., account numbers, log-in info, authentication, identification, etc.).

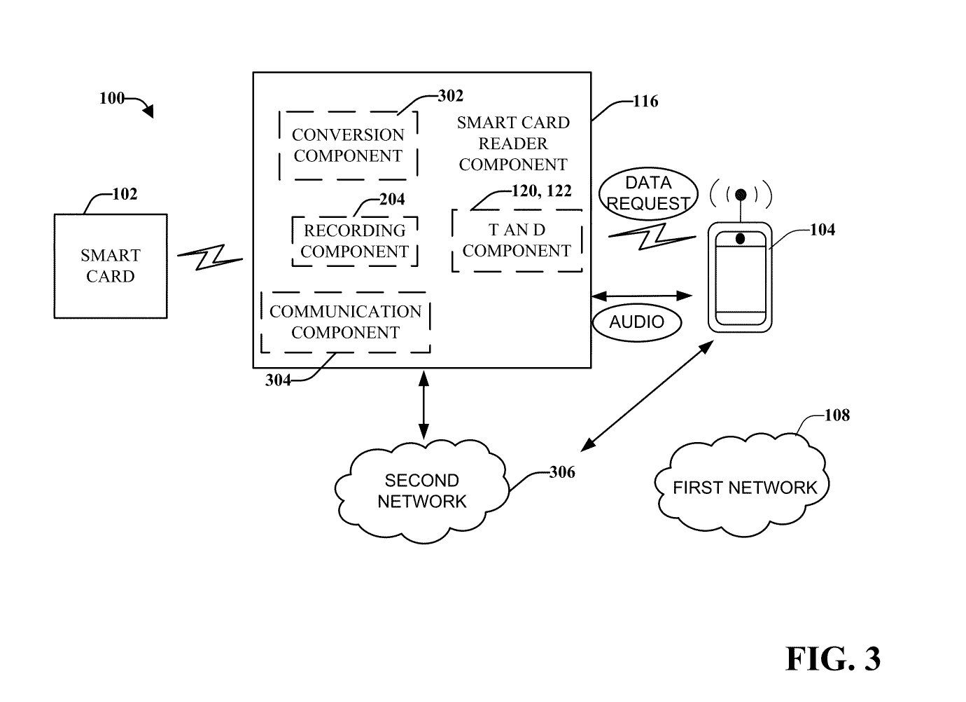

FIG. 3 illustrates an example of a system 300 with a smart card reader component in accordance with various aspects disclosed herein. The smart card reader component 116 comprises the transaction and digital signature component 120,122, the recording component 204, a conversion component 302, an access and communication component 304. The smart card reader component 116 reads, extracts, identifies and/or updates data on the smart card 102. A second network 306 is in communication with the smart card reader component 116 and a mobile device 104.

In one embodiment, the smart card reader component 116 is a personal, mobile, wireless device that a user keeps along with payments, identification cards, and/or other smart cards with personal data thereon. Upon desiring to enter into a transaction, such as a financial and/or other type of communication (e.g., sharing and/or gifting products or services), the user interacts the card reader component 116 with at least one smart card 102. The smart card reader component 116 reads data from the smart card 102 with an NFC communication, a card reader head communication such as with a magnetic stripe, wireless communications and/or a wired communication component or transceiver that the communication component 304 comprises. The smart card reader component 116 can then be coupled to the mobile device 104 (e.g., a smart phone and the like) to extend the smart phone into a payment device that can also utilized NFC communication, wireless communication, and/or other communication protocols to communicate the data read from the smart card and process payments or other transactional information.

The conversion component 302 is configured to convert digital data, such as images, digital objects, digits, and/or data signals into auditory or other data for communication to a network 306 and/or to the mobile device 104 that is in connection with a first network 108. The second network 306 can be a cloud network, a WAN, LAN, MAN, and the like, in which personal data can be stored and updated by a vendor of a smart card and/or a user. For example, address information as it relates to the personal identification data stored on the smart card 102, and/or other types of data, such as authentication data, account numbers, etc., can be stored on the smart card 102 via the smart card reader and/or the mobile device 102. This enables a user to updated, rather than replace a smart card. The communication component 304 is configured for a two way communication between the smart card 102 and the smart card reader component 116.

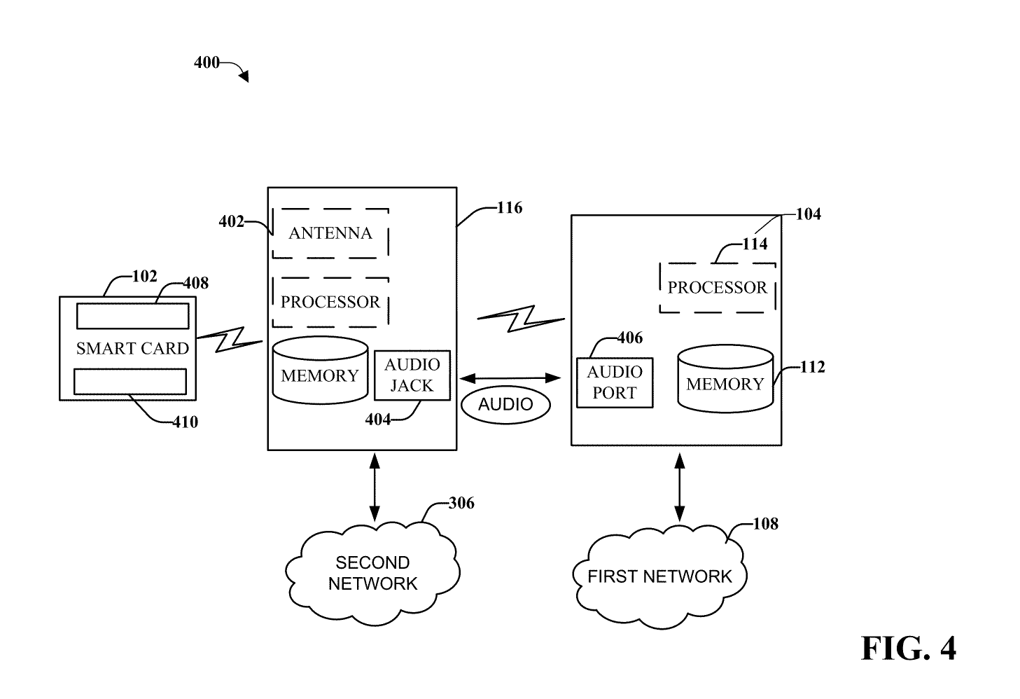

FIG. 4 illustrates another example of a system 400 with a smart card reader component 116 in accordance with various aspects disclosed herein. The smart card reader component 116 is communicatively connected to the computer device 104, such as a mobile device or personal computer. An online transaction or interaction with applications of a network via various application programming interfaces can occur with the network 108 and/or the network 306. The smart card reader component 116 includes an antenna for NFC and wireless communication (e.g., radio and the like) with the computer device 104 and the smart card 102. The smart card reader component 116 further includes an audio jack 404 that can insert into an audio port 406 of a computer device, cash register or other type device that can receive and process audio data. When combined with the computer device 104, the computer device can become a mobile money device having the transactional data, account data, personal identification, an electronic signature and a authentication component that initiates processing of a transaction online for an integrated user experience. The user, thus does not need to sign, type, enter any information since the information for all steps of the transaction are executed by the joined computer device and the smart reader component in response to data being read from the smart card. The system 400 can thus recognize criteria requested by an online application or portal and fill fields for the information to process a transaction related to a good or service. For example, a processor of the smart card reader component 116 can communicate the audio data to an online application based on a set of criteria, such as indicators of a payment field, a PIN field, address request field, and the like for information generated by the smart card reader component 116 from the smart card 104.

The smart card 102 includes a first interface 408, such as a magnetic stripe that produces a signal indicative of data encoded on the stripe, such as transactional or account data and other data. The smart card 102 can also include a second interface 410, such as an NFC chip that enables powering of the smart card 102 in response to the smart card being proximately located (e.g., less than a few centimeters, or other such distances) to the antenna 402 of the smart card reader component. In response to powering of the card, the smart card 102 communicates data requested by the online application on the network 108 and/or 306.

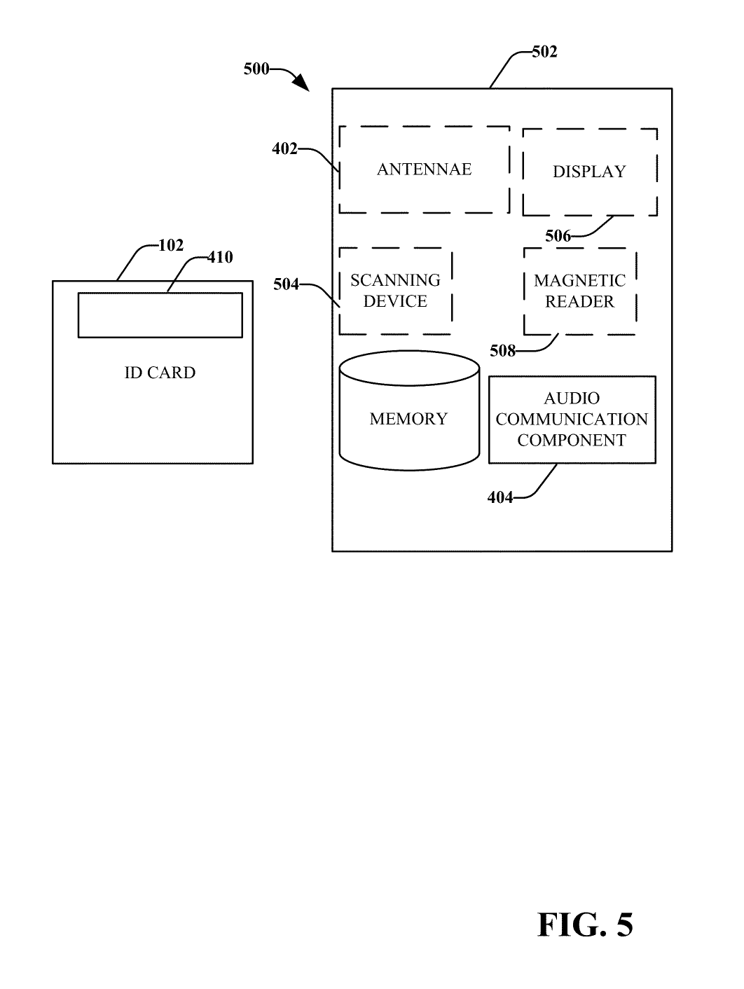

FIG. 5 illustrates an example of a card and a card reader component in accordance with various aspects disclosed herein. A card reading component 502 has a scanning device 504 that is operable to scan image data and/or other data that is proximately located to the card reader 116. The scanner component 504 is operable to scan for signals and operate as a transceiver as well as scan imagery to be stored into the memory of the smart card reader component 502. For example, the antennae 402 can enable the card to be detected and then the scanning device scan images such as identification data, and/or photo data. Additionally, the magnetic reader component 508 can operate as a slot with sensors that read magnetic information from the magnetic stripe 410. A display 506 is configured to display the data received and/or play the data in an audio format upon the data received from the card being converted to audio data by the reader component. An audio communication component includes a jack, such as stereo jack, audio jack and the like. Other connections can also be includes such as a USB connector, or other type connectors. The audio communication component 404 operates to communicate the data obtained from the card, such as identification data, payment data, magnetic data and the like in order to process a transaction with a computer device connected to a network.

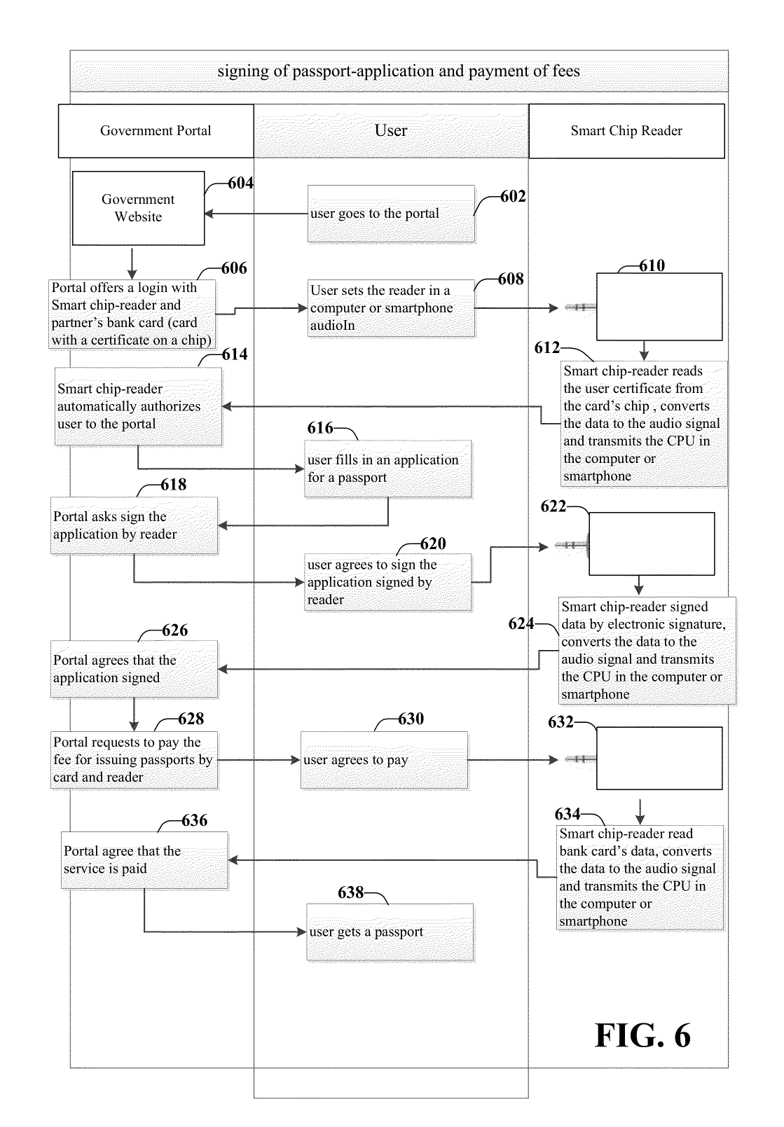

FIG. 6 illustrates an exemplary process flow according to various aspects disclosed herein, in which a user utilizes the functions of the smart card reader component discussed herein for an online experience, such as for applying for a passport with an online application and paying fees related to the application process. The process flow initiates at 602 as a user navigates to an online portal, such as to a government portal at a government site 604. At 606, the portal offers a login with a smart chip reader or a smart card reader component. In response, the user at 608 sets the smart chip reader in a computer or mobile device through an audio port. The smart chip reader at 610 reads a smart card and converts the data on the smart card into audio data to be read through the audio port. At 612, the smart chip reader, for example, reads a user certificate from the card's processor, converts the data to an audio signal and transmits to the processor of the computer or smart phone (e.g., a mobile device). At 614, the smart chip reader authorizes the user to the portal with authentication data read from the card. The certificate data can be authentication data, for example, such as a personal identification number, a photo, a key, password, further certificate or license, etc., that verifies and/or authenticates at least part of the audio data (e.g., account/transaction data, identity or personal identification data, digital signature, etc.).

At 616, a user can fill in an application, such as for a passport in this example. The application, however, can be for any product or service of a networked application, such as for purchase of any good/service (e.g., tickets, cleaning, landscaping, etc.), in which the networked application can be any online application of a shopping portal, remote host, server or client (e.g., a financing or credit card company, truck rental, etc.).

At 618, the portal requests the application to be signed. The requests discussed herein can be identified by the smart card/chip reader component and/or received in a communication. For example, a communication can include a specific request via Wi-Fi, NFC, Bluetooth, etc. for a part of the audio data, such as authentication, verification, identity, payment data, signature data, etc. Additionally or alternatively, the request can be an identified field, such as a signature line in the case of a signature data, or digital signature needed, and thus, the request can be an identified and/or a communicated requested of the smart card reader component. At 620, the user agrees to sign the application signed by the reader via a confirmation, signaling or initiating communications between the smart card reader and a networked device, such as computer device 104 discussed above, or any networked device.

At 622, the smart card reader component initiates processing of the signature data. The smart card reader can identify the electronic signature or signature data stored thereat without further user of the smart card, and/or extract from the smart card further signature data by NFC, magnetic swiping, and/or any other communication protocol. At 624, the smart card reader component identifies the electronic signature, converts the data to audio data, and communicates at least part of the audio data for the signature to a computer device and/or other networked device. At 626, the portal responds as if the application is signed. At 628, the portal requests that the fee for issuing the product or service be paid (e.g., issuing a passport), and at 630 the user agrees or does not agree that the payment be processed. If the user agrees, at 632 the smart chip card reader component can identify the payment or transactional data stored thereat without further user of the smart card, and/or extract from the smart card the payment data by NFC, magnetic swiping, and/or any other communication protocol. For example, at 634 the smart card reader component can read the smart card, credit card, or other card and convert the payment data identified on the card into an audio data, and transmit the data in audio format, NFC format or other format wirelessly and/or wired to a networked device (e.g., a mobile phone or other device). At 636, the portal receives payment and agrees that the service is paid. The user then receives the service and/or good paid for, at 638.

While the methods or process flows described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

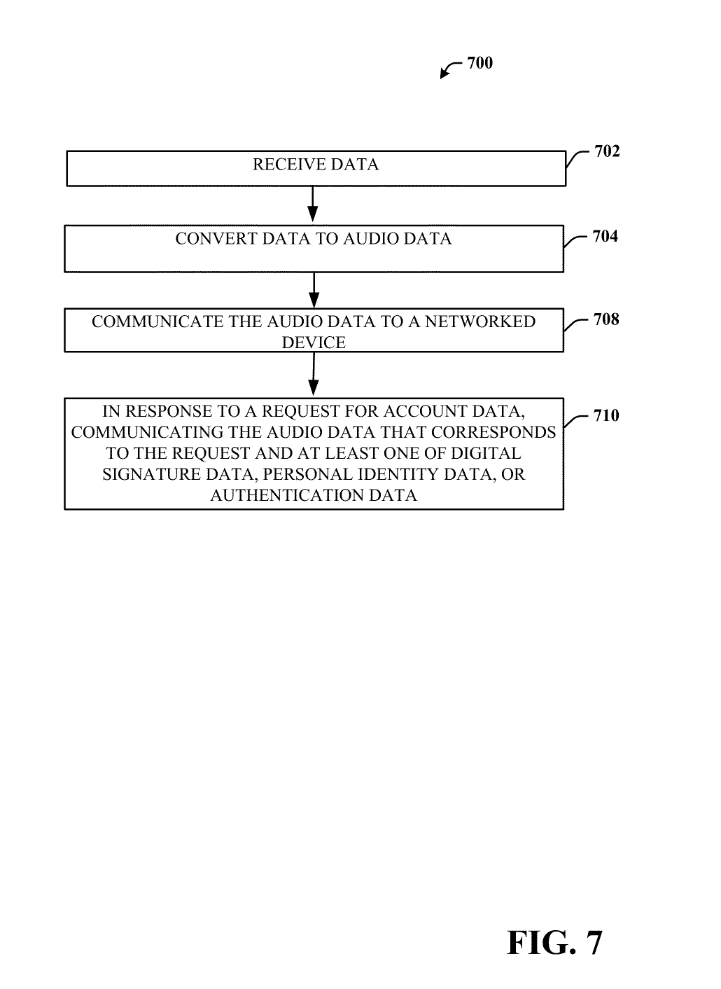

An example methodology 700 for implementing a method for a system that provides an integrated online experience with a smart card reader component is illustrated in FIG. 7. Reference is made to the figures described above for ease of description. However, the method 700 is not limited to any particular embodiment or example provided within this disclosure.

FIG. 7 illustrates the exemplary method 700 for a system in accordance with aspects described herein. The method 700, for example, provides for a system read payment data and signature data form a smart card and communicate via an audio format and/or other formatted protocols to a network device for payment, identification, authentication and/or signature to a transaction.

At 702, the method begins with receiving data, such as digital data or other data from a credit card, smart card, IC card, SIM card and the like via a magnetic stripe, NFC communication protocols, Bluetooth, Wi-Fi, etc. At 704, the data received is then converted into audio data. At 708, a smart card/chip reader communicates the audio data to a networked device (e.g., a mobile device, smart phone, laptop, and/or wired device in communicated with a network). At 710, in response to a request, such as from an online application, a networked application and the like, the audio data is communicated or transmitted to the online application for a transaction related to a good or service, for example. The request can be for an accounting data, transactional data, credit card data, etc., as well as be other request for identity or personal identification data, a signature (e.g., an electronic signature) and/or authentication data (e.g., a PIN, key, token, login, photo, photo id, scanned id, etc.) to verify or authenticate at least part of the audio data. The request, for example, can be for accounting data and the account information obtained from a card by the reader component communicates this data in response to a request (whether identified or received). In addition, the smart card reader can communicate a digital signature, personal identity data, and/or authentication data to further progress, complete, or supplement the transaction.

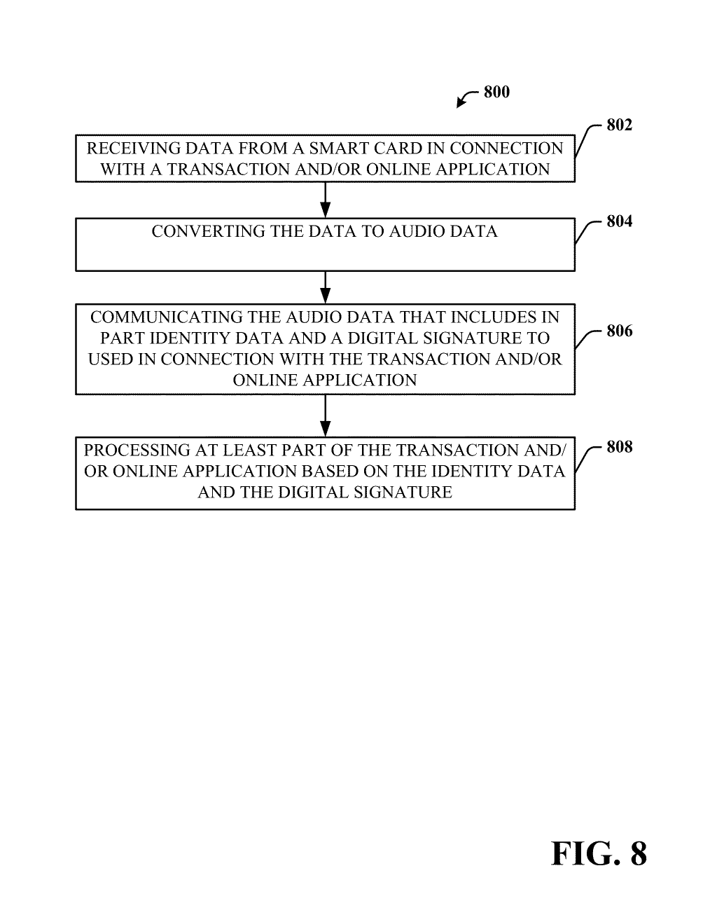

An example methodology 800 for implementing a method for a system to process an online application or transaction is illustrated in FIG. 8. Reference may be made to the figures described above for ease of description. However, the method 1000 is not limited to any particular embodiment or example provided within this disclosure.

The method 800, for example, provides for a system to process an online application and/or transaction for goods or services. At 802, data is received from a smart card and/or a credit card and converted to audio data for communication via an audio output component, such as an audio jack component. At 806, the method includes communicating the audio data that includes in part identity data (e.g., birth date, address, name, age, photo, etc.) and a digital signature to be used in connection with a transaction and/or an online application. At 808, the transaction and/or online application is processed with based on the identity data and the signature data.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

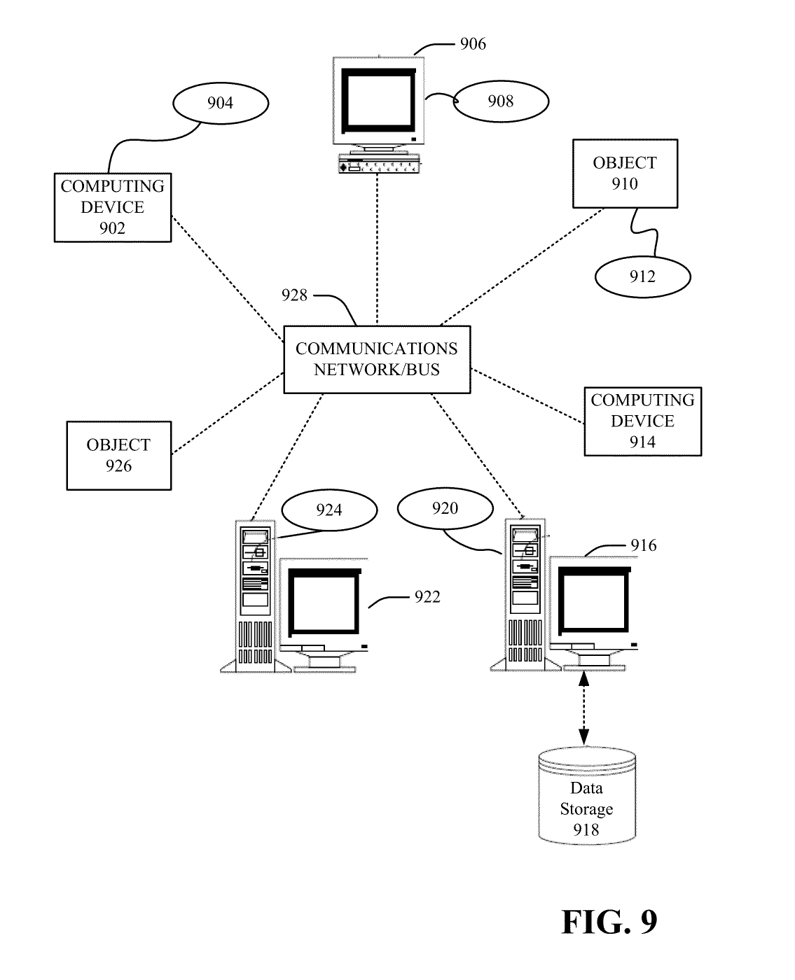

FIG. 9 provides a schematic diagram of an exemplary networked or distributed computing environment. The distributed computing environment comprises computing objects 910, 926, etc. and computing objects or devices 902, 906, 910, 914, etc., which may include programs, methods, data stores, programmable logic, etc., as represented by applications 904, 908, 912, 920, 924. It can be appreciated that computing objects 912, 926, etc. and computing objects or devices 902, 906, 910, 914, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, etc. can communicate with one or more other computing objects 910, 912, etc. and computing objects or devices 920, 922, 924, 926, etc. by way of the communications network 928, either directly or indirectly. Even though illustrated as a single element in FIG. 9, communications network 928 may comprise other computing objects and computing devices that provide services to the system of FIG. 9, and/or may represent multiple interconnected networks, which are not shown. Each computing object 910, 926, etc. or computing object or device 920, 922, 924, 926, etc. can also contain an application, such as applications 904, 908, 912, 920, 924, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, etc. can be thought of as clients and computing objects 910, 926, etc. can be thought of as servers where computing objects 910, 926, etc., acting as servers provide data services, such as receiving data from client computing objects or devices 920, 922, 924, 926, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 926, etc. can be Web servers with which other computing objects or devices 920, 922, 924, 926, etc. communicate via any of a number of known protocols, such as the hypertext transfer protocol (HTTP). Computing objects 910, 912, etc. acting as servers may also serve as clients, e.g., computing objects or devices 920, 922, 924, 926, etc., as may be characteristic of a distributed computing environment.

### Exemplary Computing Device

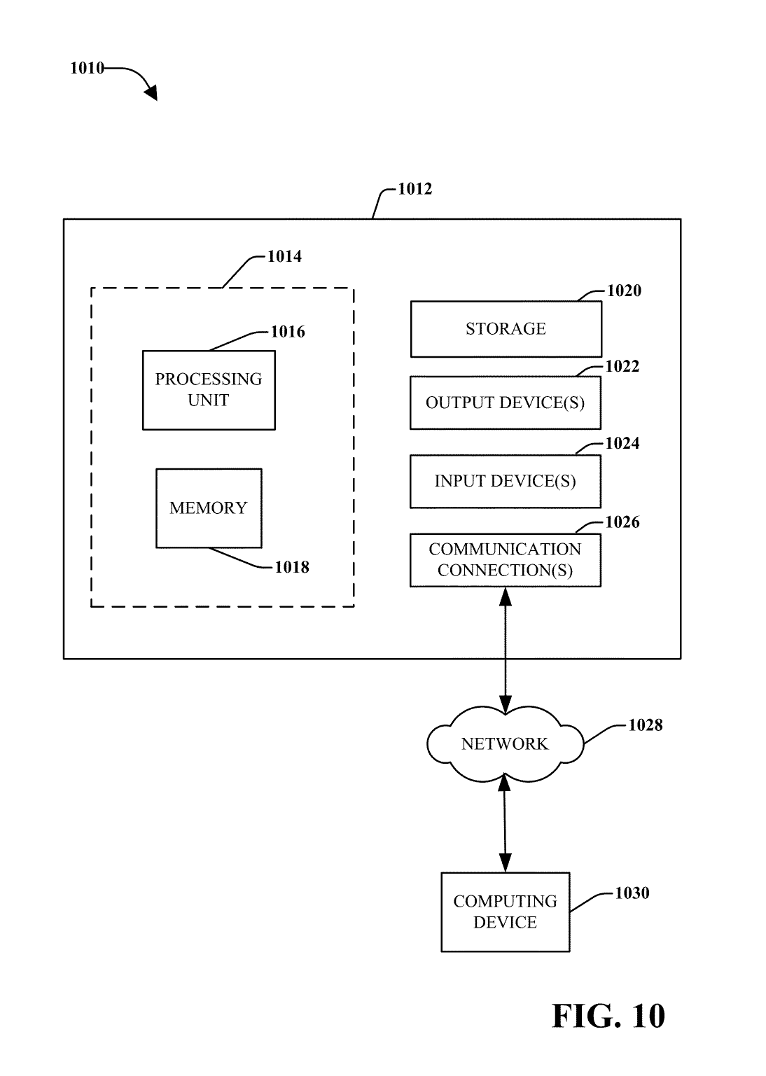

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components, and a processor, communicatively coupled to the memory, that facilitates execution of the computer-executable components, the computer-executable components including:
a smart card reader component configured to convert data read from a smart card to audio data in connection with a transaction for a product or a service;
a digital signature component configured to, in response to reception of the audio data, determine digital signature data including personal identification data from the audio data; and
a transaction component configured to process at least a portion of the transaction based at least in part on the digital signature data.

2. The system of claim 1, wherein the transaction component is further configured to communicate the personal identification data to a first network device in response to a request for the personal identification data from the first network device or in response to a request for the personal identification data included in an online application.

3. The system of claim 1, the computer-executable components further comprising a display component coupled to the smart card reader component configured to facilitate display of the personal identification data.

4. The system of claim 2, the computer-executable components further comprising:
an authentication component configured to determine authentication data based on authentication of at least one of payment data, the digital signature data or the personal identification data for the transaction.

5. The system of claim 4, wherein the transaction component is communicatively coupled to a first network and is configured to communicate at least one of payment data related to the transaction, the digital signature data, the personal identification data or the authentication data in response initiation of at least the portion of the transaction.

6. The system of claim 4, wherein the transaction component is configured to communicate the audio data based at least in part on a request for at least one of payment data, the digital signature data, the personal identification data or the authentication data.

7. The system of claim 1, wherein the smart card reader component is configured to communicate with the smart card via a near field communication (NFC) protocol, a magnetic stripe, a Bluetooth communication protocol, or a Wi-Fi protocol.

8. The system of claim 1, wherein the smart card is communicatively coupled to the smart card reader component and at least one of the smart card reader component or the smart card, and is configured to receive, update and store the digital signature data via communications with a remote storage accessible via one or more networks.

9. The system of claim 1, wherein the transaction component is further configured to receive and record at least one receipt of a communication between the smart card reader component and a first network device that relates to the transaction, wherein the at least one receipt includes at least part of the digital signature data.

10. The system of claim 1, wherein the smart card reader component is removable from the smart card, and is configured to communicate wirelessly with a network device for the transaction.

11. The system of claim 10, wherein the smart card reader component is configured to store the audio data from the smart card without the smart card.

12. The system of claim 1, further comprising a network device including an audio port and is configured to communicate via a near field communication with the smart card or the network device.

13. The system of claim 1, wherein the smart card is a removable smart card having a first interface that communicates with the smart card reader component via physical contact to the smart card reader component, and a second interface that communicates with the smart card reader component without physical contact with the smart card reader component, and the smart card is powered in response to being proximately located to an antenna of the smart card reader component.

14. The system of claim 1, wherein the transaction component is further configured to communicate the digital signature data for application to a digital document related to the transaction to electronically sign the digital document.

15. An apparatus comprising:
a memory storing computer-executable instructions; and
a processor, communicatively coupled to the memory, that facilitates execution of the computer-executable instructions to at least:
convert data read from a smart card to audio data in connection with a transaction for a product or service of a networked application;
determine, from the audio data, digital signature data including an identity;
authenticate the identity associated with the digital signature data;
initiate performance, in response to authentication of the identity, of at least a portion of the transaction; and
communicate at least part of the audio data to the networked application.

16. The apparatus of claim 15, wherein the processor further facilitates execution of the computer-executable instructions to:
communicate to the networked application the audio data based on a set of criteria.

17. The apparatus of claim 15, wherein communication of the at least part of the audio data further comprises:
communication with an audio jack configured to enable communication of the audio data to the networked application.

18. The apparatus of claim 15, wherein the processor further facilitates execution of the computer-executable instructions to:
communicate with the smart card via a near field communication (NFC) protocol, a magnetic stripe, a Bluetooth communication protocol, or a Wi-Fi protocol.

19. The apparatus of claim 18, wherein the processor further facilitates execution of the computer-executable instructions to:
communicate with the smart card to receive, update and store at least a portion of the digital signature data on the smart card via communication with a remote storage accessible via one or more networks.

20. The apparatus of claim 15, wherein the processor further facilitates execution of the computer-executable instructions to:
record at least one receipt or communication with the online application via the first network, wherein the at least one receipt includes at least part of the digital signature data.

21. The apparatus of claim 15, wherein the processor further facilitates execution of the computer-executable instructions to:
receive the data from the smart card via physical contact with the smart card, and without physical contact with the smart card in response to the smart card being proximately located to an antenna communicatively coupled to the processor.

22. The apparatus of claim 15, wherein the audio data includes at least one of a digital signature data that the processor communicates to electronically sign a digital document for the transaction.

23. The apparatus of claim 22, wherein the audio data includes personal identification data that the processor communicates to identify ownership information.

24. The apparatus of claim 23, wherein the processor further facilitates execution of the computer-executable instructions to:
in response to reception of a request for the audio data, communicate to the networked application at least one of the digital signature data, the personal identification data or authentication data that authenticates the identity associated with the digital signature data, based on the request.

25. A method, comprising:
receiving, by a smart card reader component including at least one processor, data from a smart card in connection with a transaction or online application for a product or a service;
converting the data to audio data;
communicating, in response to reception of the audio data, the audio data that includes in part identity data and a digital signature to be used in connection with processing the transaction or online application; and
processing at least part of the transaction or online application based on the identity data and the digital signature.

26. The method of claim 25, further comprising:
receiving the audio data that includes payment data, the digital signature, the identity data, and an authentication data that authenticates at least part of the audio data.

27. The method of claim 26, further comprising at least one of:
populating a transaction field of a networked application with the payment data in response to identification of a request for the payment data;
populating an application field of the networked application with the identity data in response to identification of a request for the identity data;
populating the digital document with the digital signature in response to identification of a request for the digital signature; or
populating an authentication of the audio data in response to identification of a request for identity information.

28. The method of claim 27, wherein the populating the identity data includes communicating at least one of a name, photo, address, or a date of birth.

29. The method of claim 25, further comprising:
displaying the audio data in a display of a mobile device.

30. The method of claim 25, further comprising:
storing the data from the smart card to a memory of the smart card reader component.

31. The method of claim 25, further comprising:
communicating the audio data to a networked application via a first network from the smart card reader component; and
recording on the smart card reader component at least one receipt of a communication from the communicating of the audio data to the networked application, wherein the at least one receipt includes at least part of the digital signature data.

32. The method of claim 31, further comprising:
receiving, updating and storing data stored on the smart card via a communication with a remote storage accessible via one or more networks.

33. The method of claim 25, wherein the receiving the data from the smart card includes receiving the data without physical contact of the smart card to the smart card reader component and in response to the smart card being proximately located to the smart card reader component.

34. The method of claim 25, wherein the communicating the audio data includes communicating the audio data via an audio jack of the smart card reader component.

35. The method of claim 25, wherein the communicating the audio data includes communicating the digital signature data that the processor communicates to electronically sign a digital document for the transaction or the online application.

36. A computer readable storage medium comprising computer executable instructions that, in response to execution, cause a computing system including at least one processor to perform operations, comprising:
receiving, by a smart card reader component, a data from a smart card;
converting the data to audio data;
communicating the audio data via an audio jack to a computer device that is communicatively coupled to a first network; and
in response to a request from the first network including account data, communicating at least a part of the audio data that corresponds to the request and at least one of digital signature data, personal identification data, or authentication data.

37. The computer readable storage medium of claim 36, the operations further including:
in response to receiving a request for account data, communicating the account data to the first network to process a transaction;
in response to receiving a request for the digital signature, communicating the digital signature to a digital document of a networked application;
in response to receiving a request for the personal identification data, communicating the personal identification data to the networked application; or
in response to receiving a request for the authentication data, communicating the authentication data to the networked application.

38. The computer readable storage medium of claim 36, the operations further including:
communicating the audio data to the networked application via the first network from the smart card reader component and the computer device; and
recording on the smart card reader component a receipt of a communication from the communicating of the audio data.

39. The computer readable storage medium of claim 36, the operations further including:
receiving, updating and storing data stored on the smart card from the smart card reader component via a near field communication.

40. A system comprising:
means for reading and generating audio data from data stored on a smart card;
means for providing at least part of the audio data to an online application for a transaction in response to determining at least personal identification data from the audio data; and
means for communicating at least part of the audio data based on a request from the online application via the network, wherein the audio data includes transaction data, digital signature data or authentication data.

41. The system of claim 40, further comprising:
means for recording a receipt of a communication from the communicating of the audio data to the online application via the means for communicating; and
means for receiving, updating and storing data stored on the smart card.
